(19) United States
(12) Patent Application Publication
(10) Pub. No.: US 2009/0189315 A1
(43) Pub. Date: Jul. 30, 2009

(54) Method for the Production of a Ceramic Shaped Body and a Shaped Body Produced by the Method

(75) Inventors: Jens Günster, Deutschland (DE); Jürgen Heinrich, Deutschland (DE); Andrè Gahler, Haag (CH); Thomas Wiest, Hunfeld (DE); Stephan Dierkes, Bremen (DE)

Correspondence Address: BROMBERG & SUNSTEIN LLP, 125 SUMMER STREET, BOSTON, MA, 02110-1618, US

(73) Assignees: BEGO Bremer Goldschlagerei Wilh. Herbst GmbH & Co. KG, Bremen (DE); Technische Universitat Clausthal, Clausthal (DE)

(21) Appl. No.: 12/094,751

(22) PCT Filed: Nov. 21, 2006
(86) PCT No.: PCT/EP06/68706

§ 371 Date: Sep. 24, 2008

(30) Foreign Application Priority Data
Nov. 22, 2005 (DE) 10 2005 055 524.1

(51) Int. Cl. C04B 35/64; B06B 1/02; B29B 13/00

(52) U.S. Cl. 264/442; 264/678; 264/482; 425/317

(57) ABSTRACT

The invention relates, inter alia, to a method for the production of a ceramic shaped body (22), comprising the following steps:
production or provision of a green body (10) having a structured surface region (12),
irradiation of at least the structured surface region (12), so that the green body (10) is consolidated in the region of a volume zone (16) including the structured surface region (12), but is not consolidated or is consolidated to only a lesser degree in volume zones further from the surface,
separation of the consolidated volume zone (16) including the structured surface region (12) from parts of the green body (10) which have not been consolidated or have been consolidated to only a lesser degree, and optionally
scouring of the consolidated volume zone (16) obtained in this way.

The invention relates to a method for the production of a ceramic shaped body. The invention furthermore relates to a shaped body produced by the method.

Ceramic shaped bodies are made entirely or at least to considerable proportions of ceramic materials. They can be produced by heat treatment starting from a so-called green body. There is only little adhesion between the individual particles of the green body. The ceramic body of high strength is obtained only by a treatment at high temperatures, i.e. by sintering the components of the green body.

Ceramic products require defined times and a suitable atmosphere for sintering. If these conditions are not adhered to, increased internal stresses, defects on the workpiece or inadequate properties are the result. Typical sintering temperatures are, for example, 1,600-1,800° C. for aluminium oxide, approx. 1,300° C. for steatite, approx. 1,250° C. for alumina porcelain and approx. 1,700° C. for silicon nitride.

The high temperatures during sintering lead to a decrease in the specific free surface area of the particles (diffusion methods, formation of melts, phase conversions) and therefore to a compaction of the structure, accompanied by a reduction in volume. This decrease in volume is called “shrinkage” and indicates the percentage decrease in size of the component from the green body to the fired shaped body. The shrinkage can vary widely for different materials. Accordingly, as a rule, the non-fired green body for the mouldings must be shaped to a larger size than the required finished article, since a decrease in the volume of components occurs with almost all materials in the method sequence as a peculiarity of ceramics technology. A basic problem of existing production methods for ceramic shaped bodies accordingly lies in the shrinkage, which makes production difficult, in particular for compact shaped bodies, and increases waste.

In the publication “A novel route for the production of ultra pure SiO₂ crucibles” by J. Gunster, S. Engler, J. G. Heinrich, F. Schwertfeger in Glass Sci. Technol. 78 (2005), 18-22, a method is described with which a crucible can be produced from a crucible-shaped SiO₂ green body by irradiating the surface with a CO₂ laser. The crucible produced by this method has on its inside a quartz layer which has melted because of the laser treatment and then solidified again.

The present invention is based on the object of providing a simple and precise production method for ceramic shaped bodies, in particular having flat uneven structures, which can be handled reliably and are resistant.

This object is achieved by the method according to claim 1. The invention is based on the finding that a ceramic shaped body can be produced in a simple manner and with a high accuracy if the production comprises the following steps:
production or provision of a green body having a structured surface region,
irradiation of at least the structured surface region, so that the green body is consolidated in the region of a volume zone including the structured surface region, but is not consolidated or is consolidated to only a lesser degree in volume zones further from the surface,
separation of the consolidated volume zone including the structured surface region from parts of the green body which have not been consolidated or have been consolidated to only a lesser degree, and optionally
scouring of the consolidated volume zone obtained in this way, i.e. of the ceramic shaped body.

According to the present method, the green body accordingly is not consolidated completely to give a compact shaped body, but by its outer contour it defines an area (called “structured surface region” here) which is consolidated at the surface down to a predeterminable depth (called “consolidated volume zone” here after the consolidation) by introduction of energy. A temperature gradient is built up in the green body by the irradiation with a sufficiently high energy density. Regions of the green body which are not or not sufficiently consolidated can easily be separated off from the consolidated structure after the irradiation. The contour of the irradiated outer surface of the shaped body produced essentially corresponds to the contour of the outer surface of the green body. It is accordingly largely determined by the shape or shaping of the green body. The contour of an opposite outer surface of the shaped body produced which is not irradiated directly results from the boundary of the consolidated volume zone and thus results from the irradiation parameters chosen (in this context see also below).

As a result of the invention, the compaction of the structured surface region of the green body does not lead to shrinkage in the conventional sense. Since the green body is heated only externally and diffusion and melting methods, which in the end lead to a compaction, are thereby stimulated only in a relatively thin zone close to the surface, the irradiated green body remains stable in its contours.

The shrinkage which is nevertheless always associated with the compaction is accomplished by a contraction of the green body propagating perpendicular to the shaped body surface such that the outer compacted volume zone shrinks on the non-compacted core of stable contours of the green body. Distortions in geometry such as occur again and again with conventional sintering of ceramic green bodies and are difficult to predict therefore do not have to be taken into account. This renders possible a design of the non-sintered green body tight on the final contour of the ceramic shaped body to be established, with its flat but uneven structure.

“Green body” (or also powder compact, blank or green compact) is understood as meaning a moulding produced from an (initially loose or pre-compacted) pulverulent material. The individual particles of the pulverulent material are compacted during the production of the green body and brought into a cohesive form which has sufficient strength for subsequent handling. A suitable shaping method is as a rule chosen from economic aspects and includes known methods, such as dry pressing, wet pressing, isostatic pressing, extrusion, injection moulding, slip casting, film casting, deposition from a slip, milling and 3D printing of green bodies.

“Scouring” in the present case means the separating off of projecting material from the consolidated volume zone obtained beforehand. Thus, for example, in the case of flat irradiation, the consolidated volume zone can be greater than the flat but uneven structure to be produced on the shaped article. The projecting material is then separated off, for example, by laser cutting.

The methods during consolidation of the volume zone, i.e. in particular during sintering, are very complex and proceed differently according to purity, grain size, packing density and firing atmosphere. Oxide ceramic products of high purity sinter by a solids reaction and in this context require much higher sintering temperatures than compositions containing feldspar, such as e.g. porcelain having a high proportion of fused phase. If the green body to be treated comprises metal or glass, these melt during the heat treatment if the temperature reaches the melting point thereof. Alternatively or in addition, the metals react with the atmosphere (e.g. with oxygen) and/or further constituents of the green body at the high temperatures and are converted into ceramic materials in this way. After cooling and, where appropriate, resolidification of molten constituents, the desired ceramic exists. Where “consolidation” or “sintering” is accordingly referred to in the present case, these terms include, unless defined otherwise in the individual case, all the methods in the material which are described above which occur during the irradiation and during the subsequent re-cooling, that is to say in particular also the melting and resolidification and/or oxidation of metallic components.

The energy for the sintering is introduced into the material by, for example, laser. In the case of materials having a high absorption coefficient for the laser beam used, the laser energy is absorbed completely, starting from the treated surface of the green body, in a depth range comparable to the laser wavelength. For example, the absorption depth of an SiO₂ surface of a green body in a CO₂ laser beam (wavelength 10.6 μm) is about 10 μm. In principle, with an appropriate choice of the laser only a thin region close to the surface is therefore heated directly by absorption of the laser beam. Starting from the surface, the heat spreads out in the green body by thermal conduction. The temperature gradient which builds up here depends essentially on the thermal properties of the loose, precompacted or already compacted material, the radiation intensity or irradiance, the irradiation angle and the duration of the treatment. In this context, in addition to the radiation output, the diameter of the beam determines the maximum surface temperature reached. From the beam diameter, the area effectively irradiated is given by the irradiation angle.

Shaped bodies of simple structure without undercuts are preferably to be built up by the method described.

In an advantageous embodiment of the method according to the invention, a set of predetermined three-dimensional geometric data, in particular a set of predetermined three-dimensional geometric data of the structured surface region is used both (a) for production of the green body and (b) for controlling the irradiation.

The shaping methods mentioned above by way of example for production of the green body include methods in which a negative mould (as in the case of pressing or casting) is used for production of the green body, and also methods in which the green body is produced by shaping by application of material (as with 3D printing or deposition) or by shaping by removal of material. However, the shaping methods can be carried out on the basis of predetermined three-dimensional geometric data—regardless of whether a negative mould is used or the green body is produced freely without a negative mould. If a negative mould is used, this is preferably produced for the production of the green body on the basis of the predetermined three-dimensional geometric data; the green body produced with the aid of this negative mould was thus produced using the predetermined three-dimensional geometric data. On the other hand, the predetermined three-dimensional geometric data can also be used directly for production of the green body by application or removal of material.

It has been found that the use of predetermined three-dimensional geometric data for the production of the green body (having a structured surface region) not only simplifies the production thereof itself, but that additionally the geometric data already used for production of the green body can be used again in order to control the subsequent irradiation at least of the structured surface region in an optimum manner. In this way it is possible to largely or even completely dispense with an expensive regulation, which would otherwise be necessary in order to control the influence of the irradiation on the green body and sintering operation. If the predetermined geometric data include the contour data of the green body (or at least the structured surface region thereof), the irradiation can be controlled solely on the basis of these geometric data, the known system parameters, such as radiation output and focusing, and the material properties of the green body, such as absorption and thermal conduction.

The method for the production of the green body is advantageously carried out in a computer-assisted manner, in particular as rapid prototyping, wherein the predetermined three-dimensional geometric data are employed directly for production of the green body or of a negative mould intended for production of the green body.

It is furthermore also advantageous to use the set of predetermined three-dimensional data also for the method step of separation and/or optionally that of scouring. In the case of separation on the basis of the predetermined three-dimensional geometric data, for example, all the material can be removed in a targeted manner down to a limit, beyond which at least a desired consolidation exists. In the case of scouring also, an equalizing between the actual contour of the shaped body produced and the desired contour can also be carried out on the basis of the predetermined three-dimensional geometric data and the scouring can be carried out using the deviations thereby found.

An additional method step in which a surface region of the shaped body exposed by scouring is irradiated such that the shaped body is consolidated further can advantageously be provided. For example, if the surface of the shaped body opposite the structured surface after the scouring is likewise to be irradiated in the additional step in a manner corresponding to the irradiation of the structured surface of the green body, a particularly high homogeneity of the shaped body can be achieved.

Preferably, the irradiation of the green body is carried out such that
(i) a volume zone which includes the volume of the shaped body to be produced is kept overall at a temperature required for the consolidation until the consolidation has taken place,
or
(ii) volume elements which lie in a volume zone which includes the volume of the shaped body to be produced but are in each case smaller than the shaped body to be produced are kept successively at a temperature required for the consolidation until the consolidation has taken place in each case.

In a preferred variant of the method according to alternative (i), the irradiation of the green body is carried out by simultaneous irradiation of the structured surface region with a flat beam, e.g. a defocused beam, and/or a raw beam. In the case of irradiation of the green body over a large area, sintering on the surface can be achieved by an instationary temperature profile in the green body. The high energy densities needed for this are easily provided, for example, by commercial laser systems. The laser outputs required here are conventionally in the range of from 100 W to a few kW. method alternative (i) is distinguished by a relatively short processing time and a not very involved control of the beam.

In a preferred variant of the method according to alternative (i), the irradiation of the green body is carried out by successive irradiation of individual part sections of the structured surface region of the green body with a beam. If a laser beam is used, laser outputs of below 100 W are conventionally required.

Preferably, in alternative (ii) described above for the method the irradiation is controlled as a function of the location, so that the consolidated volume zone including the structured surface region has a varying thickness. For control in the abovementioned sense, preferably a) a holding time of the beam or b) a scanning speed of the beam is varied during the irradiation. Point a) is based on the knowledge that, for example, an increase in the holding time of the beam in a particular part section of the structured surface region leads to an increase in the thickness of the shaped body in this part section, since the heat introduced is greater there and therefore also the depth of the consolidated volume zone increase. Point b) takes into account that the beam must be guided over the entire structured surface region of the green body. The speed with which the beam brushes over this surface is called the scanning speed. An increase in the scanning speed leads to a lower thickness of the shaped body, whereas a slowing down in the scanning speed has the opposite effect. A continuous change in the thickness of the shaped body can be achieved by a change in the scanning speed. The scanning speed is in general composed of two components corresponding to a first and second direction. If the green body is irradiated, for example, along parallel tracks, the scanning speed is given e.g. by the speed with which the irradiation region follows a track in the X direction and the distance from adjacent tracks or the displacement between adjacent tracks in the Y direction. At a comparatively high speed in the X direction, with a short distance between tracks in the Y direction introduction of a large amount of heat and therefore a resulting deep depth of the consolidated volume zone can be achieved. The propagating heat front furthermore depends on the material properties and the contour of the green body in the part section of its surface to be irradiated.

The method according to the invention can be realized particularly advantageously if the irradiation is laser irradiation. Lasers are widely used and can be easily employed. A sufficient energy density is readily obtained with modern lasers. Other forms of irradiation which can transfer energy for sintering to the green body to a sufficient extent are also suitable. There may be mentioned here, for example, electromagnetic radiation generally, inter alia also incoherent light, but also a beam of particles, such as an electron beam.

It is furthermore preferable for the separation of the consolidated volume zone including the structured surface region from parts of the green body which have not been consolidated or have been consolidated to only a lesser degree to be carried out by one or more of the following measures: mechanical separating off; treatment of the green body with solvent and/or dispersion agent; treatment of the green body in an ultrasonic bath.

It is furthermore preferable for the green body to comprise or consist of:

(a) a ceramic powder, or
two or more different ceramic powders,
and optionally
(b) metal powder and/or glass powder
and/or
(c) binder.

Ceramic powders, i.e. pulverulent ceramic materials, are inorganic and non-metallic. As a rule they are shaped from a crude composition at room temperature and display their typical material properties in the shaped body to be produced due to the sintering operation at high temperatures. The ceramic materials include silicate, oxide or non-oxide ceramics.

A dominant proportion of fine ceramic products is silicatic in nature. Clay and kaolin, feldspar and soapstone as silicate carriers are a characterizing main constituent of these multiphase materials. In addition, components such as alumina and zirconium are also used to achieve specific material properties, e.g. high strengths. During sintering, a high proportion of vitreous phase, the essential constituent of which is silicon dioxide, is formed in addition to the crystalline phases. The materials of silicate ceramic include porcelain, steatite, cordierite and mullite.

Oxide ceramic is understood as meaning all ceramic materials which essentially comprise single-phase and one-component metal oxides (>90 wt. %). The materials are low in vitreous phase or free from vitreous phase. The raw materials are produced by synthesis and have a high purity. At very high sintering temperatures uniform microstructures are formed, which are responsible for the improved properties. Some representatives of oxide ceramic are aluminium oxide, magnesium oxide, zirconium oxide, aluminium titanate and titanium dioxide. Oxide ceramic is employed in electronics and frequently as a structural ceramic, that is to say for non-electrical uses. It offer typical properties which are suitable for this, such as fracture toughness, wear and high temperature resistance and corrosion resistance.

Non-oxide ceramic comprises ceramic materials based on compounds of boron, carbon, nitrogen and silicon. As a rule, non-oxide ceramics have a high proportion of covalent bonds. These render possible high use temperatures, ensure a high modulus of elasticity and impart high strength and hardness, together with a high corrosion resistance and wear resistance. The most important non-oxide ceramics are silicon carbide, silicon nitride, aluminium nitride, boron carbide and boron nitride.

A metallic component is added as a metal powder in the shaping method on the green body or is present in the form of ceramic particles coated with metal.

The ceramic powder preferably comprises or consists of one or more inorganic compounds chosen from the group consisting of silicon oxide, aluminium oxide and magnesium oxide. The green body preferably furthermore comprises an inorganic compound which has a reinforcing action and does not react or reacts only partly with the further components of the green body on irradiation of the structured surface region. Zirconium oxide is preferably added as a reinforcing inorganic compound. The green body furthermore preferably comprises one or more metallic or semi-metallic elements, in particular chosen from the group consisting of aluminium, magnesium, titanium, zirconium or silicon. If several metallic elements are employed, these are preferably in the form of alloys or intermetallic phases. Particles of the ceramic powders employed are furthermore preferably coated with a shell of metal. Metals can be melted at significantly lower temperatures than ceramic. They serve as a binder phase. At the same time, the increase in volume during oxidation of the metal can further increase the geometrical accuracy of the component.

The method according to the invention preferably provides the following step before the production of provision of the green body:

Defining of a flat but uneven (surface) structure of the shaped body to be produced, where the defined flat but uneven structure of the shaped body to be produced is reproduced with dimensional accuracy in the structured surface region by the green body subsequently produced or provided. In the present case, reproduction with dimensional accuracy is understood as meaning that the (slight) shrinkage induced by the sintering method is taken into account when the geometry of the structured surface region of the green body is predetermined. The defining of the (surface) structure preferably include predetermining the three-dimensional geometric data of the structured surface region.

Preferably, the green body having a structured surface region is produced by

(a) pressing, in particular dry pressing, wet pressing, isostatic pressing,
(b) casting of a slip,
(c) milling of a green body block,
(d) deposition from a slip or
(e) 3D printing of a green body (e.g. a printer from Z Corporation).

Green bodies which are particularly suitable for the further steps of the method according to the invention can be produced with the shaping methods mentioned. The moulds which are optionally to be used for the production of the green body, in particular by methods a) and b) are preferably produced in a computer-assisted manner on the basis of a set of predetermined three-dimensional geometric data. Direct production of a green body, in particular by methods c), d) and e), is advantageously carried out in a computer-assisted manner on the basis of a set of predetermined three-dimensional geometric data.

In the case of pressing (see above, (a)), the material used for production of the green body is compacted to the green body in a negative mould. Where in the present case in connection with the pressing of a green body reference is made to computer assistance and production based on a set of predetermined three-dimensional geometric data, this means in particular also the production of the negative mould used for the pressing. The same also applies to casting of a slip for production of the green body (see above, (b)).

In the case of milling of a green body (see above, (c)) from a green body block, material is removed down to the desired shape. Methods and devices for computer-assisted removal of material have been known for a long time.

Methods are known in which green bodies are produced, for example, by electrophoretic deposition from a slip (see above, (d)). This shaping of the green body by application of material can also be controlled on the basis of three-dimensional geometric data, for example by controlling the electrophoresis voltages and/or currents accordingly for individual electrodes used for production of the green body.

3D printing (see above, (e)), a method which is to be included in rapid prototyping, allows the production of a green body by application, for example in the form of layers, which is not limited, as is deposition, to an application from the inside outwards. Apparatuses which carry out 3D printing or a similar method are commercially available for the production of green bodies.

A further aspect of the invention relates to shaped bodies which can be produced with the aid of the method according to the invention described above. Shaped bodies according to the invention differ from conventional shaped bodies in that because of the production method they have a decreasing density starting from their structured surface towards their under-side. In other words, the higher temperatures in sections of the structured surface region close to the surface cause greater compaction and therefore also consolidation of the material in these sections on irradiation. The density of the shaped body is accordingly higher on the upper side (the side which has been irradiated) than on the under-side facing away from this.

Due to the absorption of the radiation in the region of the green body close to the surface, its surface is heated to a particularly high degree and therefore becomes the most compacted by thermally activated sintering methods. Deeper-lying layers of the green body are accordingly compacted less, as a result of which, depending on the duration of the treatment, a density gradient is built up in the green body such that the regions close to the surface are highly compacted and those away from the surface are scarcely or not compacted. The density is directly proportional to the strength of the material.

Since the sintering progress of a ceramic green body is essentially determined by diffusion and, where appropriate, melting methods, there is an exponential relationship between the temperature and the degree of compaction of the pulverulent material. This behaviour favours generation of thin solid layers of high compaction in the region of the green body close to the surface. The compacted region close to the surface is also called the consolidated volume zone here.

A ceramic shaped body according to the invention as a rule has a thickness of from a few dozen micrometres to several millimetres, preferably a thickness in the range of from about 0.2 to 2 mm. The thickness of the shaped body depends on the temperature profile generated in the surface of the green body during laser treatment, the material properties and the duration of the irradiation. The shaped body has a defined flat but uneven structure. The structure of the surface has elevations and depressions which project out of a geometrically averaged plane laid imaginarily through the flat structure, or into this. In other words, the flat but uneven structure assumes the shape of a three-dimensionally contoured area.

The shaped body according to the invention (as a result of the method according to the invention) is preferably a dental product, in particular a crown, a bridge, an inlay or an onlay. Due to the production method, the dental products have a decreasing density starting from the surface of the flat but uneven structure towards the under-side of this structure. In application, the dental products are conventionally under-laid with a suitable filler on their under-side, creating a connection between the tooth to be treated and the dental product. Dental products of a shaped body having a flat but uneven structure have the advantage over a compact shaped body that fitting of the dental product on to the tooth to be treated is simplified. Furthermore, a three-dimensional tooth surface can be produced with a high precision with the aid of the method according to the invention, since the shrinkage of the green body during irradiation is low and can be readily predicted. Reworking of the shaped body produced by thermal treatment to correct the shape is therefore unnecessary or simplified.

A further aspect of the invention lies in the provision of a device for the production of a ceramic shaped body from a green body having a structured surface region, comprising an irradiation unit for irradiation of the structured surface region, so that the green body is consolidated in the region of a volume zone including the structured surface region, but is not consolidated or is consolidated to only a lesser degree in volume zones further from the surface.

The invention furthermore provides a system for the production of a ceramic shaped body. comprising:
a production unit for production of a green body having a structured surface region, in particular for computer-assisted production of the green body on the basis of a set of predetermined three-dimensional geometric data, preferably on the basis of a set of predetermined three-dimensional geometric data of the structured surface region,
an irradiation unit for irradiation, in particular for computer-assisted irradiation on the basis of the set of predetermined three-dimensional geometric data, of the structured surface region, so that the green body is consolidated in the region of a volume zone including the structured surface region, but is not consolidated or is consolidated to only a lesser degree in the volume zones further from the surface, and
a processing unit for separation of the consolidated volume zone including the structured surface region from parts of the green body which have not been consolidated or have been consolidated to only a lesser degree and optionally for scouring of the consolidated volume zone obtained in this way.

The system according to the invention, like the device according to the invention, is suitable for carrying out or for use in the method according to the invention. Preferred embodiments of the system according to the invention and of the device according to the invention correspond to preferred embodiments of the method according to the invention, the required means for carrying out preferred method steps then being present.

The invention is explained in more detail in the following with the aid of exemplary embodiments and the associated drawings. The figures show:

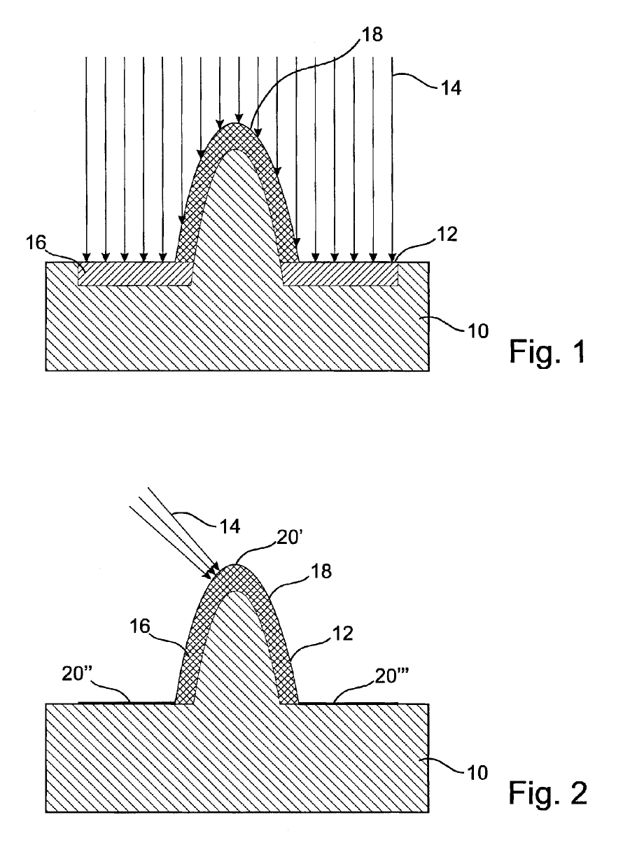

FIG. 1 an illustration in diagram form of a first variant of the method according to the invention;

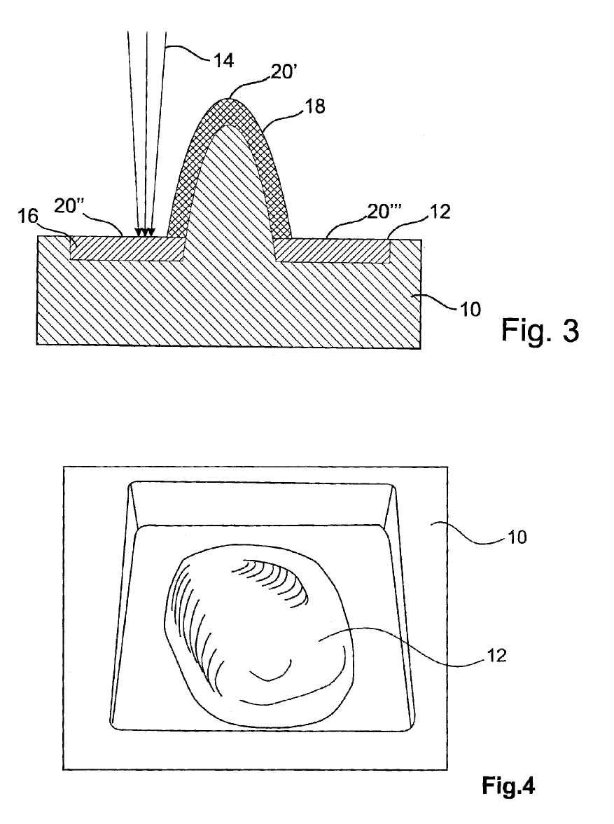

FIGS. 2 and 3 as FIG. 1, but with an alternative guiding of the laser during the irradiation;

FIG. 4 a photographic reproduction of a structured surface region of a green body;

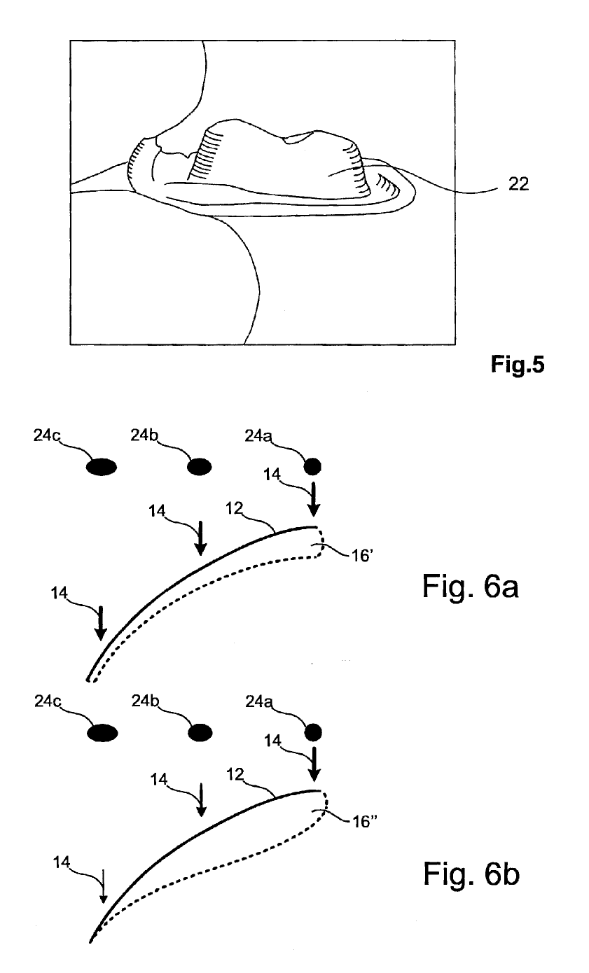

FIG. 5 a photographic reproduction of a shaped body produced by the method according to the invention and

FIGS. 6a and 6b an illustration in diagram form of the influence of the radiation output and the incident angle on the size of a consolidated volume zone.

In the following exemplary embodiments, the irradiation is carried out with a laser. Other irradiation techniques can also be used as an alternative or in addition, for example irradiation with electrons.

Reference is made in the exemplary embodiments to (a) a computer-assisted production of the green body (or its negative mould) on the basis of predetermined three-dimensional geometric data and to (b) control of the irradiation for the sintering with the aid of the data from (a). Alternatively, however, the production of the green body and control of the irradiation can of course be carried out in a conventional manner.

### EXEMPLARY EMBODIMENT 1

A green body is produced in a ceramic shaping method, in particular by dry pressing, wet pressing, isostatic pressing or slip casting, using a negative mould. The green body has in a region of its surface a structure which is compacted or sintered by means of laser irradiation and finally forms a flat but uneven structure in the shaped body to be produced. The green body can be made e.g. of SiO₂ powder.

The negative mould used for production of the green body is produced automatically beforehand on the basis of predetermined three-dimensional geometric data. Computer-assisted production methods for mouldings are widely used and generally known, so that it is not necessary to go into more detail of the production method for the negative mould itself. The person skilled in the art can find further information, in particular on the matter of the production of the negative mould, for example in DE 197 24 875.

FIG. 1 shows—in highly diagrammatic form—a section through a green body 10 in the region of its structured surface 12. The surface region 12 is matched—taking into account shrinkage of the green body 10 during the subsequent laser irradiation—in its shaping and its dimensions to the flat but uneven structure of the shaped body to be produced (i.e. the surface region 12 is dimensionally accurate to the structure to be established in the shaped body).

With a laser, a flat laser beam 14 is generated which is incident approximately perpendicularly on a plane of the surface region 12 obtained imaginarily by geometric averaging. The laser beam 14 penetrates into the surface region 12 approximately to the depth of its wavelength and is absorbed there by the material present. If a CO₂ laser is employed, the penetration depth of the laser beam 14 is about 10 μm. Starting from this upper absorption region, the heat released by the absorption spreads out into deeper zones of the green body 10. Down to a depth which depends on the material properties, the energy density of the laser beam 14 and the duration of the treatment, the temperature is sufficient to sinter the material. In other words, the green body 10 is consolidated in the region of a volume zone 16 including the structured surface region 12. This volume zone 16 is indicated in diagram form in FIG. 1. An actual depth of the volume zone 16 and therefore also the thickness of the later flat structure of the ceramic shaped body can vary over the total surface of the volume zone 16 as a function of parameters such as e.g. the incident angle of the laser beam 14 or the geometry of the structured surface 12. As can be seen, for example, the volume zone 16 deviates slightly in its depth extension in the region of the raised structure 18 from the even regions of the surface region 12. The tip of the raised structure 18 is thus consolidated more, because of its geometry and position, and the volume zone 16 is somewhat thicker there. On the other hand, the volume zone 16 is somewhat thinner by comparison on the descending flanks of the raised structure 18.

For the sintering operation, the irradiation with the laser beam is controlled on the basis of the three-dimensional geometric data already used for production of the green body. In this context, the method parameters of the laser, such as incident angle and intensity, are preferably controlled on the basis of the geometric data

For control of the incident position and the incident angle of the laser beam it is not the absolute positioning of the green body and the laser which is important, but their positions relative to one another. It is therefore clear that instead of moving the laser or the laser source, the green body can also be moved. It is likewise possible to move both the laser and the green body.

The volume zone 16 is the volume region of the green body 10 which is consolidated by the energy introduced, regions which are consolidated to only a small extent and are separated off in the subsequent method steps not being included in the volume zone 16. Regions of the volume zone 16 projecting beyond the flat but uneven structure to be established on the shaped body can be removed in later processing steps. These additional regions of the volume zone 16 serve e.g. to simplify the further treatment steps to give the desired shaped body, and can be determined individually according to the application. They can be separated off later, for example by laser cutting.

The energy density of the laser beam is chosen such that the surface of the green body 10 is heated to a maximum temperature as rapidly as possible in an instationary temperature profile. The maximum temperature is defined by framework conditions, such as thermal decomposition of the ceramic material, falling of the viscosity below a minimum value etc. When the maximum temperature is reached, this is maintained for a particular time span (holding time) by controlling the laser output. Successively deeper-lying zones are sintered by the heat front which propagates approximately perpendicularly from the surface region 12 into the inside of the green body 10. The holding time correlates with the thickness of the volume zone 16.

After a predetermined holding time, the laser treatment is stopped and the structure is detached from the loose, non-compacted or only slightly compacted material of the green body 10. This can be effected mechanically—with and without the aid of a solvent—or in an ultrasonic bath with solvent.

### EXEMPLARY EMBODIMENT 2

The method again starts from a green body 10, which corresponds in nature and dimensions to the green body 10 of Exemplary embodiment 1. In this respect, reference is made to the preceding statements. In FIG. 1-3 the same reference symbols are used for the same or similar features.

However, the green body is produced with an alternative method to the method described in Exemplary embodiment 1. For production of the green body, a precursor body in the form of a block is produced, from which the actual green body is produced by computer-assisted shaping by removal of material, for example milling. Computer-assisted shaping by removal of material or alternatively application of material is known. For example, DE 199 30 564 A1 describes such a method and DE 201 05 248 U1 describes a suitable milling machine.

In contrast to Exemplary embodiment 1, in the method procedure according to Exemplary embodiment 2 the laser treatment is limited locally, i.e. does not take place simultaneously in the entire area of the surface region 12 to be treated. As shown in FIGS. 2 and 3, for this a laser beam 14 is focused on particular part sections 20′, 20″, 20′″ of the surface region 12 which are to be treated. Sintering methods are induced in the part sections 20′, 20″, 20′″ by the energy introduced there, down to a depth which depends on the temperature profile. The entire surface region 12 is scanned by the laser beam 14, so that in turn overall a volume zone 16 is formed which contains the flat but uneven structure to be generated on the shaped body, or corresponds to this.

The advantage of a mere local laser irradiation is that in the irradiated part sections 20′, 20″, 20′″ in each case a thickness of the volume zone 16 can be varied by adaptation of the laser output, holding time or scanning speed. Thus, for example, it is possible first, as shown in FIG. 2, to consolidate only part section 20′, which includes the raised structure 18, by local laser irradiation. An energy introduction by the laser beam 14 can then subsequently be modified by controlling the laser output, and the thickness of the volume zone 16 in the even part sections 20″, 20′″ of the surface region 12 can thus be adjusted independently of the thickness of the volume zone 16 in the part section 20′ including the raised structure 18.

By a local laser irradiation, such as can be seen from FIGS. 2 and 3, in contrast to Exemplary embodiment 1 described above accordingly in each case only a part section 20′, 20″, 20′″ of the surface region 12 of the green body 10 is irradiated. In the part section 20′, 20″, 20′″ irradiated by means of laser, the energy density of the laser beam is chosen such that this part section 20′, 20″, 20′″, or subsections lying therein, is heated to a maximum temperature as rapidly as possible in an instationary temperature profile. The (sub)section heated in this way is a volume element of the volume zone 16. The maximum temperature is defined by framework conditions, such as thermal decomposition of the ceramic material, falling of the viscosity below a minimum value etc.

By scanning over the area of the surface region 12 of the green body 10 with the laser beam 14, that is to say successive triggering of the individual part sections 20′, 20″, 20′″ with the laser, the flat but uneven structure of the later shaped body is consolidated. Depending on the scanning speed, a certain time span (holding time) in which the maximum temperature is maintained results for each part section 20′, 20″, 20′″ or subsection. By the heating being limited to part sections 20′, 20″, 20′″ or subsections, the sintering method can be controlled locally, and e.g. the thickness of the shaped body to be generated can thus be varied locally.

Successive deeper-lying zones (the volume elements of volume zone 16) are sintered by the heat front propagating approximately radially, cylindrically or perpendicularly to the surface, depending on the geometry of the particular part sections 20′, 20″, 20′″ or subsections treated by the laser, into the inside of the green body 10. The holding time and therefore the scanning speed correlate with the thickness of the sintered area.

The three-dimensional geometric data used for production of the green body are used for computer-controlled guiding of the laser beam. In this context, both the desired path of the point of impingement of the laser and the intensity and focusing thereof are adjusted in a simple and efficient manner such that the green body is subjected to the desired sintering, it being possible for regulation for monitoring of the laser output introduced and the position of the laser beam to be largely dispensed with.

According to the publication “A novel route for the production of ultra pure SiO₂ crucibles” by J. Gunster, S. Engler, J. G. Heinrich, F. Schwertfeger in Glass Sci. Technol. 78 (2005), 18-22, for example, a regulating method is provided in which the temperature of the molten quartz glass is measured by means of a suitable optical system and a pyrometer during the laser treatment. The laser beam is controlled with the aid of the surface temperature measured by the pyrometer. However, if the parameters which determine the introduction of energy into the green body are known, in particular the geometry thereof, the laser can also be controlled without such a feedback, which allows a corresponding simplification of the apparatus and is preferable according to the invention.

After the laser treatment the volume zone 16 is separated from the loose or only slightly consolidated parts of the green body 10. This can in turn be carried out mechanically—with and without the aid of a solvent—or in an ultrasonic bath in solvent.

FIG. 4 shows a photograph of a structured surface region 12 of a green body 10.

FIG. 5 shows a photograph of a shaped body produced by the method according to the invention. The shaped body 22 is a dental product, specifically part of a crown, and must still be converted by scouring into the final form necessary for the application.

FIGS. 6a and 6b show an illustration in diagram form of the influence of the radiation output and the incident angle on the size of a consolidated volume zone. The surface region 12 is substantially identical in FIGS. 6a and 6b. According to FIG. 6a, laser irradiation is carried out with a beam 14 of constant intensity. Because of the surface structure 12, the beam 14 in each case meets the surface 12 at a different angle. This results in different impingement areas, which are indicated by areas 24a, 24b and 24c. The energy introduced per unit area becomes lower with increasing distortion of the impingement area 24a, 24b, 24c. This leads to different heating up of the particular region and therefore to a different depth of the volume zone 16′ in which a desired compaction occurs. The laser irradiation according to FIG. 6b largely corresponds to that according to FIG. 6a. Nevertheless, according to FIG. 6b a different intensity or output of the laser beam 14 is used, which is symbolized by the arrows of different thickness. This has (like the shape or size of the impingement area) effects on the depth of the compaction of the volume zone 16″. Different three-dimensional geometries of the volume zones 16′ and 16″ therefore result, according to FIG. 6a and, respectively, FIG. 6b, cf. in particular the broken contour lines.

1. A method for the production of a ceramic shaped body, the method comprising:
producing a green body having a structured surface region,
irradiating at least the structured surface region, so that the green body is consolidated in the region of a volume zone including the structured surface region, but is consolidated to a lesser degree in volume zones further from the surface;
separating the consolidated volume zone including the structured surface region from parts of the green body which have been consolidated to a lesser degree, and
scouring of the consolidated volume zone obtained in this way.

2. A method according to claim 1, wherein a set of predetermined three-dimensional geometric data of the structured surface region is used for producing the green body and for control of the irradiation.

3. A method according to claim 1, further comprising irradiating a surface region of the shaped body which has been exposed by the scouring, so that the shaped body is consolidated further.

4. A method according to claim 1, wherein the irradiating is carried out such that
(i) a volume zone which includes the volume of the shaped body to be produced is kept overall at a temperature required for the consolidation until the consolidation has taken place.

5. A method according to claim 4, wherein the irradiation is carried out by simultaneous irradiation with a flat beam.

6. (canceled)

7. A method according to claim 1, wherein the irradiating comprises laser irradiation.

8. A method according to claim 1, wherein the separation of the consolidated volume zone including the structured surface region from parts of the green body which have been consolidated to a lesser degree is carried out by one or more of the following measures: mechanical separating off; treatment of the green body with solvent, treatment of the green body with dispersion agent; and treatment of the green body in an ultrasonic bath.

9. A method according to claim 1, wherein the green body comprises materials selected from the group consisting of:
a ceramic powder,
two or more different ceramic powders,
metal powder, glass powder and
binder.

10. A method according to claim 1, comprising, before the production of the green body:
defining of a flat but uneven structure of the shaped body to be produced, where the defined flat but uneven structure of the shaped body to be produced is reproduced with dimensional accuracy in the structured surface region by the green body subsequently produced or provided.

11. A method according to claim 1, wherein the ceramic shaped body to be produced is a dental product selected from the group consisting of a crown, a bridge, an inlay and an onlay.

12. A method according to claim 1, wherein production of the green body having a structured surface region is carried out by one of
pressing, dry pressing, wet pressing, isostatic pressing,
casting of a slip,
milling of a green body block,
deposition from a slip, and
3D printing of a green body.

13. A shaped body produced by a method according to the method of claim 1.

14. A shaped body according to claim 13, wherein the shaped body is a dental product selected from one of a crown, a bridge, an inlay or an onlay.

15. A device for the production of a ceramic shaped body from a green body having a structured surface region, comprising an irradiation unit for irradiation of the structured surface region, so that the green body is consolidated in the region of a volume zone including the structured surface region, but is consolidated to a lesser degree in volume zones further from the surface.

16. A system for the production of a ceramic shaped body, comprising:
a. a production unit adapted for computer assisted production of a green body having a surface region, structured based on a set of predetermined three-dimensional geometric data of the structured surface region,
b. an irradiation unit for computer-assisted irradiation on the basis of the set of predetermined three-dimensional geometric data, of the structured surface region, the irradiation unit operable so that the green body is consolidated in the region of a volume zone including the structured surface region, but is consolidated to a lesser degree in volume zones further from the surface, and
c. a processing unit for separation of the consolidated volume zone including the structured surface region from parts of the green body which have been consolidated to a lesser degree.

17. A method according to claim 16, wherein the structured surface region that is consolidated to a lesser degree is not consolidated.

18. A method according to claim 16, wherein the processing unit is adapted to scour the resulting consolidated volume zone.

19. A method according to claim 1, wherein the structured region that is consolidated to a lesser degree is not consolidated.

20. A method according to claim 1, wherein the irradiation of the green body is carried out such that volume elements, which lie in and are smaller than a volume zone which includes the volume of the shaped body to be produced and are smaller than the shaped body to be produced are kept successively at a temperature required for the consolidation until the consolidation has taken place in each element.

21. A method according to claim 18, wherein the irradiation is controlled as a function of location, so that the consolidated volume zone including the structured surface region has a varying thickness.

22. A method for the production of a ceramic shaped body, the method comprising:
providing a green body having a structured surface region;
irradiating at least the structured surface region, so that the green body is consolidated in the region of a volume zone including the structured surface region, but is consolidated to a lesser degree in volume zones further from the surface; and
separating the consolidated volume zone—including the structured surface region from parts of the green body which have been consolidated to a lesser degree.
